(19) United States
(12) Patent Application Publication
(10) Pub. No.: US 2026/0319443 A1
(43) Pub. Date: Oct. 15, 2026

(54) COUPLING FOR CHRONOGRAPH

(71) Applicant: Greubel Forsey S.A., La Chaux-de-Fonds (CH)

(72) Inventors: Florian CORNEILLE, Mathay (FR); Yann DUBOIS, Le Locle (CH)

(21) Appl. No.: 19/475,834

(22) PCT Filed: Apr. 18, 2024
(86) PCT No.: PCT/EP2024/060477

§ 371 Date: Oct. 16, 2025

(30) Foreign Application Priority Data
Apr. 21, 2023 (EP) 23169219.5

(51) Int. Cl. G04F 7/08

(52) U.S. Cl. CPC G04F 7/0833; G04F 7/0804

(57) ABSTRACT

The invention relates to a coupling (1) for a chronograph, comprising: an input gear (5) mounted on an arbour (3) and arranged to be driven by a finishing gear;-an output gear (9) arranged on the arbour (3) and arranged to drive at least one chronograph counter; a coupling disc (11) constrained to rotate with a first one of the input gear (5) and the output gear (9), arranged between these gears and axially movable between a first position in which it is kept in contact with a second one of the input gear (5) and the output gear (9) by an elastic element (13) such that the output gear (9) can pivot in synchrony with the input gear (5), and a second position in which it is separated from the second one of the input gear (5) and the output gear (9) by an actuator such that the input gear (5) can pivot with respect to the output gear (9); characterised in that the coupling (1) further comprises a braking wheel (21) coaxial with the input gear (5) and in gentle friction contact with the latter, the braking wheel (21) being arranged to cooperate with a brake (27) arranged to be controlled in synchrony with a return-to-zero hammer such that the brake (27) blocks the braking wheel (21) when the chronograph is reset to zero.

### TECHNICAL FIELD

The present invention relates to the field of timepieces. It more particularly concerns a vertical coupling for a chronograph.

### PRIOR ART

So-called “vertical” couplings are commonly used to produce a disengageable kinematic link between the drive train of a timepiece movement and a chronograph mechanism. They have the advantage of being compact in the plane of the movement and that when the coupling is actuated there is no risk of the seconds counter jumping upon actuation of the coupling since driving is effected by friction rather than by cooperation between teeth as is the case in a horizontal coupling or sliding pinion coupling.

A classic vertical coupling, one example of which is disclosed in the document EP3869278A1, comprises an input wheel permanently kinematically connected to the drive train, or even integrated into this latter, and an output wheel that is coaxial with the input wheel and is mounted on a common arbor, one or other of the input wheel and the output wheel being able to pivot relative to the common arbor. A friction disc constrained to rotate with the output wheel is arranged on said arbor between said wheels and is held in contact with the input wheel by an elastic element in order to constrain said wheels to rotate together by friction between the input wheel and the coupling disc. A pincer or a lever can raise the coupling disc against the force of the elastic element and therefore break the contact between the coupling disc and the input wheel. This breaks the kinematic connection between the input wheel and the output wheel.

The pincer or the lever is typically controlled by a column wheel, a shuttle, a cam or similar, with the aim of stopping or starting the counting of time. When the user wishes to reset the counter to zero after stopping the counters, the coupling is disengaged and one or more hammers act on cams to return the counters to a zero indication.

During rotation of the counters, the output wheel of the coupling can be driven and the construction tolerances can be such that when the coupling is re-engaged, catch-up of the play has to be effected before the chronograph is driven again. The starting of the counters is therefore delayed.

Consequently the object of the invention is to propose a coupling for a chronograph in which the shortcomings mentioned above are at least partially overcome.

### DISCLOSURE OF THE INVENTION

More precisely, the invention relates to a coupling for a chronograph as defined by claim 1. Said coupling comprises:
an input gear mounted on an arbor and arranged to be driven by a drive train, preferably by being kinematically branched-on to this latter;
an output gear arranged on said arbor and arranged to drive at least one chronograph counter;
a coupling disc constrained to rotate with a first of said input gear and said output gear, arranged between these latter and mobile axially between a first position in which it is held in contact with a second of said input gear and said output gear under the effect of an elastic element such that said output gear can pivot synchronously with said input gear (that is to say said gears are effectively constrained to rotate with one another under normal conditions of operation of the coupling, due to the friction generated) and a second position in which it is separated from said second of said input gear and said output gear under the effect of an actuator, such as a pincer or a lever, such that said input gear is able to pivot relative to said output gear.

According to the invention, said coupling further comprises a braking wheel coaxial with and in sliding contact with said input gear, said braking wheel being arranged to cooperate with a brake arranged to be driven synchronously with a zero reset hammer such that the brake blocks said braking wheel during resetting to zero of said chronograph.

By these means, during resetting to zero the cooperation between, on the one hand, the immobilized braking wheel and, on the other hand, the input gear is such that this latter cannot be driven in rotation the wrong way by inevitable parasitic friction present in the coupling, notably at the level of certain components mounted to rotate freely on the arbor. Controlling the friction between the input gear and the blocking wheel makes it possible to overcome the effect of parasitic friction and thus to prevent unwanted pivoting that would generate play take-up when the coupling is engaged again, without recourse to friction-fit cooperation, which would compromise the functioning of the drive train and the regulating system.

Advantageously, said braking wheel comprises teeth having a modulus of at most 50%, preferably at most 25%, that of said input gear. Unwanted pivoting of the braking wheel when it is cooperating with said brake can therefore be minimized or even eliminated. In an example that has proven to function efficaciously, the input gear had a tooth modulus of 0.07 mm and that of the braking wheel was 0.016 mm, the ratio therefore being 23%.

Advantageously, said brake comprises a beak arranged to cooperate with said teeth of said braking wheel. However, brakes operating by friction or similar are equally possible.

Advantageously, said brake is mounted so as to pivot between a first position in which it is separated from said braking wheel, which is therefore not immobilized, and a second position in which it cooperates with said braking wheel to immobilize it.

Advantageously, said brake is advantageously controlled so as to be moved between said first and second positions by a cam controlled by said hammer, or alternatively by any type of element fulfilling this function (such as a lever, etc.), preferably via a rack carried by the latter. Alternatively, a shaped cam, a rack or any other suitable element can be used for the same purpose but the solution employing a cam and a rack is particularly simple and compact.

Advantageously, said output gear is constrained to rotate with said coupling disc, while said input gear is mounted to rotate freely on said arbor.

Advantageously, said input gear is mounted to rotate freely on an intermediate ring that is also mounted to rotate freely on said arbor, said braking wheel being constrained to rotate with said intermediate ring.

Advantageously, said contact between said input gear and said braking wheel is obtained by means of a plurality of contact elements carried by one or other of said input gear and said braking wheel, preferably by said braking wheel. This facilitates control of the friction between the braking wheel and the input gear.

Advantageously, said contact elements are made of ruby, but they can alternatively be made of diamond, synthetic diamond or any other material having a low coefficient of friction.

Advantageously, said coupling disc is constrained to rotate with said output gear by means of said elastic element, but, of course, other alternative solutions are known to the person skilled in the art.

The coupling according to the invention can be integrated into a chronograph mechanism for a timepiece that further comprises:
at least one counter kinematically linked to said output gear and provided with a reset cam;
a zero reset hammer arranged to cooperate with said reset cam.

Said brake is arranged to immobilize said blocking wheel during resetting to zero of said chronograph.

### BRIEF DESCRIPTION OF THE DRAWINGS

Other details of the invention will become more clearly apparent on reading the following description in reference to the appended drawings, in which:

FIG. 1 is an isometric sectional view of a coupling according to the invention;

FIG. 2 is a view in lateral section of the coupling of FIG. 1, certain key interactions being indicated by standard symbols (in particular “X” for constrained to rotate together, “I I” for free to rotate);

FIG. 3 is an isometric view of a part of the coupling from FIG. 1 depicting its cooperation with the brake.

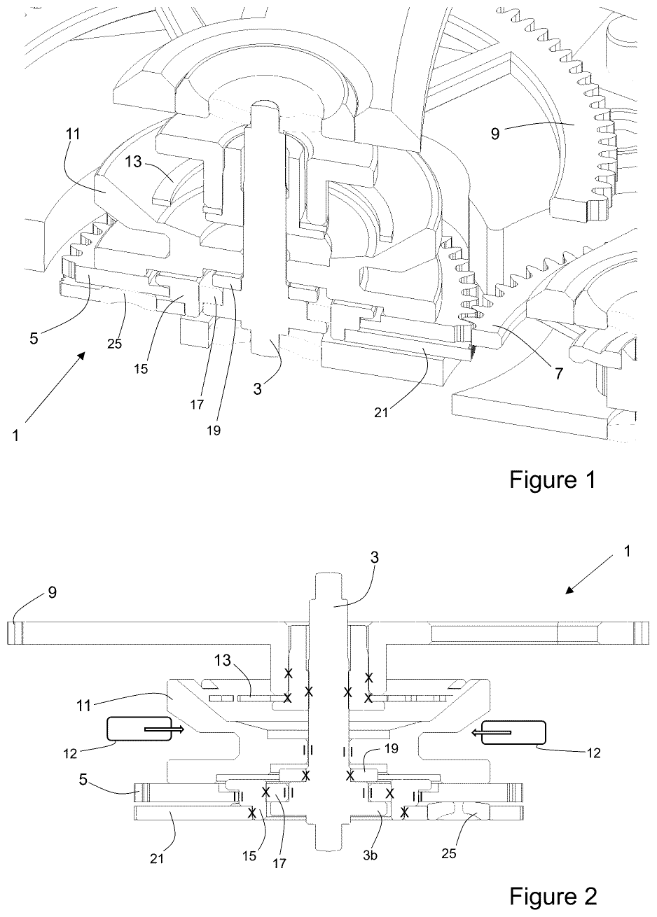

### EMBODIMENT OF THE INVENTION

The coupling 1 according to the invention is of the vertical type, its main components being arranged on an arbor 3. This coupling 1 is adapted to be used in conjunction with a chronograph mechanism, this term being understood in a broad sense, encompassing any way of counting a unit of time that can be started and stopped at will, whether it be a classic chronograph, a countdown timer or similar.

In order to receive force from the movement and its drive source, an input gear 5 is mounted to rotate freely on the arbor 3 and meshes directly or indirectly with a gear 7 of the drive train, typically the seconds gear, but this can be chosen at will. At the other end of the arbor 3 is arranged an output gear 9 that is constrained to rotate with said arbor 3 and meshes directly or indirectly with at least one chronograph counter (not depicted). The ratio of the diameters of the gears 5, 9 can be chosen at will but in the embodiment depicted the output gear 9 has a greater diameter than the input gear 5.

In order to provide a disengageable kinematic link between the input gear 5 and the output gear 9, a coupling disc 11 is provided between the input gear 5 and the output gear 9. This coupling disc 11 is mobile in translation along the arbor 3 and is subjected to a return force by an elastic element 13 in order to retain it in a first position against a lateral face of the input gear 5 such that the cooperation between these two elements generates sufficient friction to constrain them to rotate together for any torque to which the coupling 1 will be subjected during operation.

The coupling disc 11 can slide on the arbor 3 at least longitudinally and is constrained to rotate with the output gear 9 by the particular shape of the elastic element 13, which comprises a central part 13a presenting an opening of non-circular form mounted on a section 3a of complementary non-circular form of said arbor 3 and by the ends 13b of a plurality of arms 13c that engage with respective notches 11a provided in the coupling disc. The arms 13c of the elastic element 13 are prestressed (it is noted that in the figures the arms 13c are depicted without prestress but the person skilled in the art understands that when the ends 13b are engaged in the notches 11a, the arms 13c will flex) so as to provide sufficient force to press the coupling disc 11 against the face of the input gear 5 as mentioned above.

In this way, when the coupling 1 is in its engaged state, the input gear 5 is constrained to rotate with the output gear 9 by the coupling disc 11 and the elastic element 13.

The coupling disc 11 is furthermore adapted and sized to cooperate with an actuator 12 such as a pincer or a lever (depicted schematically as a pincer in FIG. 2) in known manner, to lift the coupling disc 11 against the return force of the elastic element 13 to place it in a second position and thereby break the kinematic link between the input gear 5 and the output gear 9. In this way, in the disengaged state of the coupling 1, the input gear 5 can pivot relative to the output gear 9.

Of course, other arrangements of the braking disc 11 and its elastic element 13 are possible and are known to the person skilled in the art, insofar as the operation described above is produced. Furthermore, it is equally possible to reverse the links between the gears 5, 9 and the arbor 3, which is to say that it is possible for the input gear 5 to be constrained to rotate with the arbor 3 and the output gear 9 to rotate freely, the other modifications to the arrangements of the coupling disc 11 and the elastic element 13 being within the reach of the person skilled in the art.

During resetting of the counters of the chronograph to zero it can happen that the output gear 9 is driven in rotation through a relatively large angle in one direction or the other. Because of the friction between the various components arranged on the arbor 3 it can happen that the input gear 5 is driven in rotation in the opposite direction by the arbor 3. Then, when the coupling 1 is re-engaged, the play generated in this way must first be compensated before the counters restart.

The solution implemented by the present invention is as follows.

The input gear 5 is mounted on the arbor 3 by means of an intermediate ring 15 that is constrained to rotate with a bearing 17, typically a ruby ring, but this component be omitted if its function can be exercised by the intermediate ring 15, for example if this latter is provided with a layer of a hard material such as adamantine carbon or similar.

The bearing 17 is mounted so as to be freely rotatable on the arbor 3, and the input gear 5 is mounted so as to be freely rotatable on the intermediate ring 15. So that the ring 15—bearing 17 assembly can be retained axially on the arbor 3, this latter comprises a shoulder 3b against which the bearing 17 is placed, and a retaining ring 19 is fixed onto the arbor 3 facing the shoulder 3b such that the bearing 17 is axially captured (except for a functional clearance) between these two elements 3b, 19.

A braking wheel 21 is mounted on and constrained to rotate with the intermediate ring 15, and cooperates through friction with the input gear 5, via a plurality of contact elements 25. These latter are depicted here in the form of pierced stones of ruby or other hard material, but can alternatively be formed by studs, bosses or similar, or even by simple flank-to-flank contact with the input gear 5. Of course, in another variant that is not depicted, the intermediate ring 15 can be omitted, its functionality being exercised by an appropriate shoulder surface comprised by the braking wheel 21.

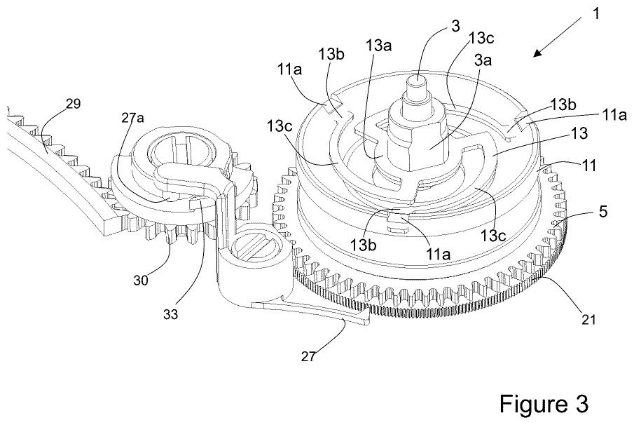

When resetting to zero takes place, a brake 27 (see FIG. 3) cooperates with the periphery of the braking wheel 21. In the embodiment depicted here, the brake 27 is a beak pivotably mounted on a frame element (not depicted) which cooperates with peripheral teeth, the modulus of which is less than that of the input gear 5. The modulus of the teeth of the braking wheel 21 is preferably between ⅙ and ½, preferably between ⅕ and ⅓, that of the input gear 5. Alternatively, the brake can cooperate with the perimeter of the braking wheel 21 by friction.

The brake 27 is controlled as a function of the movement of the zero reset hammer of the chronograph. In the non-limiting embodiment illustrated, the hammer comprises a rack 29 that cooperates with a pinion 30 constrained to rotate with a cam 33. This latter cooperates with a follower 27a which is rigidly connected to the brake 27 and which drives pivoting of this latter to produce its cooperation with the braking wheel 21 when the hammer cooperates with the reset cams (not depicted). Alternatively, the hammer can comprise a shaped cam (without teeth), a ratchet or any other suitable element instead of the rack 29, and the cam 33 can be replaced by a lever, a finger or any other suitable element. However, other arrangements controlled directly or indirectly by a column wheel, a shuttle, a control cam or similar are equally possible.

For good control of friction between, on the one hand the braking wheel 21 and the input gear 5 and on the other hand the input gear 5 and the intermediate ring 15, and on the other hand the bearing 17 and the arbor 3, the input gear 5 is prevented from pivoting in the wrong direction during resetting to zero and compensation of the above-mentioned play is therefore avoided.

Regarding friction, the cooperation between the braking wheel 21 and the input gear 5 is not “friction-fit”. Even though that would function, the braking force generated in this way would risk braking the drive train and could have a negative influence on the operation of the oscillator. It could be considered that the cooperation between these components is “sliding-fit”, that is to say between “friction-fit” and “free rotation”, the level of friction being adapted to be sufficient to overcome that coming from the arbor 3 during resetting to zero in the opposite direction, without being excessive.

By these means, the disturbance of the drive train can be minimized, the additional resistance offered to the drive train when the brake 27 is engaged being minimal.

Of course, other forms of brakes and their actuators are possible.

It is also noted that if the user holds the brake 27 blocked against the braking wheel 21, the drive train continues to function in an entirely normal manner (in contrast to a standard coupling system where drive train is blocked and the oscillator is disturbed, and even worse stops after a certain time), without any disturbance to the oscillator: this therefore enables the user to “prepare” a chronometric measurement by holding said brake and, at the moment when he releases it, the measurement starts with no latency time.

Insofar as the usable materials are concerned, the whole range of contemporary timepiece materials can be envisaged (metals, non-metals such as silicon, silicon compounds, synthetic diamond, sapphire, structurable glasses, ceramics, glass-ceramics, metallic glasses, polymers, composite materials, materials suitable for additive manufacturing, etc.). Furthermore, flexible pivots can find an application for elements where this makes technical sense.

Although the invention has been described with reference to particular embodiments, further variants are possible without departing from the scope of the invention as defined by the appended claims.

1. Coupling for a chronograph comprising:
an input gear mounted on an arbor and arranged to be driven by a drive train;
an output gear arranged on said arbor and arranged to drive at least one chronograph counter;
a coupling disc constrained to rotate with a first of said input gear and said output gear, arranged between these latter and mobile axially between a first position in which it is held in contact with a second of said input gear and said output gear due to the effect of an elastic element such that said output gear can pivot synchronously with said input gear, and a second position in which it is separated from said second of said input gear and said output gear under the effect of an actuator such that said input gear can pivot relative to said output gear;
wherein said coupling further comprises a braking wheel coaxial with and in sliding contact with said input gear, said braking wheel being arranged to cooperate with a brake arranged to be driven synchronously with a zero reset hammer such that said brake blocks said braking wheel during resetting to zero of said chronograph.

2. Coupling according to claim 1, in which said braking wheel comprises teeth having a modulus of at most 50%, preferably at most 25%, of that of said input gear.

3. Coupling according to claim 2, in which said brake comprises a beak arranged to cooperate with said teeth of said braking wheel.

4. Coupling according to claim 1, in which said brake is mounted to pivot between a first position, in which it is separated from said braking wheel, and a second position, in which it cooperates with said braking wheel.

5. Coupling according to claim 4, in which said brake is controlled so as to be moved between said first and second positions by a cam controlled by said zero reset hammer, preferably via a rack carried by this latter.

6. Coupling according to claim 1, in which said output gear is constrained to rotate with said coupling disc, said input gear being mounted to rotate freely on said arbor.

7. Coupling according to claim 6, in which said input gear is mounted to rotate freely on an intermediate ring that is also mounted to rotate freely on said arbor, said braking wheel being constrained to rotate with said intermediate ring.

8. Coupling according to claim 6, in which said contact between said input gear and said braking wheel is obtained by means of a plurality of contact elements carried by one or other of said input gear and said braking wheel, preferably by said braking wheel.

9. Coupling according to claim 8, in which said contact elements are made of ruby.

10. Coupling according to claim 6, in which said coupling disc is constrained to rotate with said output gear by means of said elastic element.

11. Chronograph mechanism for a timepiece comprising:
a coupling according to claim 1;
at least one counter kinematically linked to said output gear and comprising a reset cam;
a zero reset hammer arranged to cooperate with said reset cam,
in which said brake is arranged to block said braking wheel during resetting to zero of said chronograph.

12. Timepiece movement comprising a chronograph mechanism according to claim 11.

13. Timepiece comprising a timepiece movement according to the claim 12.
